(19) United States
(12) Patent Application Publication
(10) Pub. No.: US 2025/0142010 A1
(43) Pub. Date: May 1, 2025

(54) READING APPARATUS, RECORDING APPARATUS, AND CONTROL METHOD

(71) Applicant: CANON KABUSHIKI KAISHA, Tokyo (JP)

(72) Inventor: WATARU SUZUKI, Kanagawa (JP)

(21) Appl. No.: 18/923,292

(22) Filed: Oct. 22, 2024

(30) Foreign Application Priority Data
Oct. 27, 2023 (JP) 2023-185102

(51) Int. Cl. H04N 1/00

(52) U.S. Cl. CPC H04N 1/00602; H04N 1/00408; H04N 1/00782

(57) ABSTRACT

A reading apparatus includes a first roller pair configured to convey a document in a first direction, a reading unit provided downstream of the first roller pair in the first direction and configured to read the document, a second roller pair provided downstream of the reading unit in the first direction and configured to convey the document, a discharge port provided downstream of the second roller pair in the first direction and configured to discharge the document out of the apparatus, a motor configured to drive the second roller pair, a sensor configured to detect a rotation of the motor, and a control unit configured to, when the sensor detects a predetermined rotation of the motor while the document having been read by the reading unit is held and stopped via the second roller pair, drive the second roller pair to discharge the document from the discharge port.

### BACKGROUND

### Field of the Disclosure

The present disclosure relates to a reading apparatus, a recording apparatus, and a control method.

### Description of the Related Art

Generally, a scanner unit of a multifunction printer (hereinafter referred to as an MFP) supporting large size paper often adopts a sheet feed method to downsize an apparatus main body. By the sheet feed method, a document is conveyed under a fixed line sensor and the document is read. Of documents read by the scanner by the sheet feed method, a small-sized document is discharged to a document reception unit, and a large-sized or long document may not be received by the document reception unit but drop out of the apparatus.

Japanese Patent Application Laid-Open No. 2005-72740 discloses an apparatus configured to stop a read document while holding a part of the document with a discharge roller according to the document length. This prevents the document from dropping out of the apparatus.

However, in the configuration discussed in Japanese Patent Application Laid-Open No. 2005-72740, after holding a part of the document with the discharge roller to prevent the document from dropping, the document holding state by the discharge roller needs to be released when a user collects the document. As a method for releasing the document holding state, the user presses a discharge key prepared on the operation panel of the apparatus. This method requires that the user holds the document with one hand and operates the operation panel with the other hand, and leaves room for improvement from the viewpoint of usability.

### SUMMARY

Embodiments of the present disclosure are directed to providing a reading apparatus capable of improving the handling of a document on which a read operation has been performed.

According to embodiments of the present disclosure, a reading apparatus includes a first roller pair configured to convey a document in a first direction, a reading unit provided downstream of the first roller pair in the first direction and configured to read the document, a second roller pair provided downstream of the reading unit in the first direction and configured to convey the document, a discharge port provided downstream of the second roller pair in the first direction and configured to discharge the document out of the apparatus, a motor configured to drive the second roller pair, a sensor configured to detect a rotation of the motor, and a control unit configured to, in a case where the sensor detects a predetermined rotation of the motor in a state where the document having been read by the reading unit is held and stopped via the second roller pair, drive the second roller pair to discharge the document from the discharge port.

Further features of the present disclosure will become apparent from the following description of exemplary embodiments with reference to the attached drawings.

### BRIEF DESCRIPTION OF THE DRAWINGS

FIGS. 1A to 1C are schematic views illustrating a configuration of a scanner according to a first exemplary embodiment.

FIG. 2 is a block diagram illustrating an electrical component of the scanner according to the first exemplary embodiment.

FIG. 3 is a flowchart illustrating a series of a read operation of the scanner according to the first exemplary embodiment.

FIGS. 4A to 4D are cross-sectional views illustrating states of the scanner and a sensor according to the first exemplary embodiment.

FIGS. 5A to 5E illustrate relations between outputs of the sensor and a predetermined action by a user according to the first exemplary embodiment.

FIGS. 6A to 6C are schematic views illustrating a configuration of the scanner according to another exemplary embodiment.

### DESCRIPTION OF THE EMBODIMENTS

An exemplary embodiment of the present disclosure will be described below with reference to the accompanying drawings. The following exemplary embodiment does not limit the present disclosure. Not all of the combinations of the features described in the exemplary embodiment are indispensable to the solutions for the present disclosure. Relative arrangements and shapes of elements described in the following exemplary embodiment are to be considered as illustrative and not restrictive on the scope of the present disclosure. The present exemplary embodiment will be described below centering on a scanner using the sheet feed method, the scope of the present disclosure is not limited thereto. The present exemplary embodiment is also applicable to other automatic sheet conveyance apparatuses having a similar configuration.

“Recording” includes not only forming texts, drawings, and other meaningful information but also forming images, designs, patterns, and other meaningful and meaningless information on diverse types of recording media, and also includes processing recording media. Therefore, “recording” does not matter whether or not the outcome is elicitable to be perceived by the human visual sense. Although the present exemplary embodiment assumes a sheet of paper as a “document” or “recording medium”, recording media may include not only paper but also cloths and plastic films.

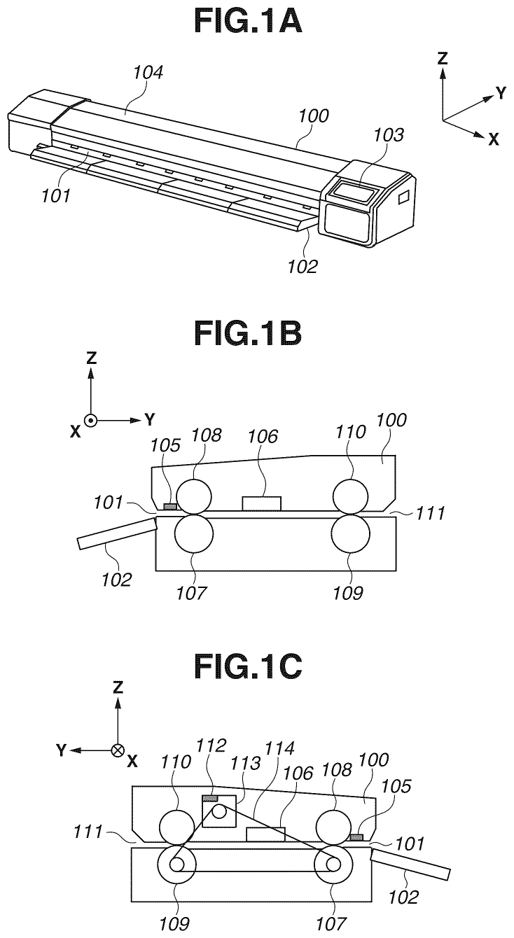

FIGS. 1A to 1C are schematic views illustrating a configuration of an image reading apparatus (scanner) 100 as an example of a sheet conveyance apparatus according to a first exemplary embodiment. The scanner 100 according to the present exemplary embodiment uses the sheet feed method for reading an image while conveying a document. FIG. 1A is a perspective view illustrating the outer appearance of the scanner 100, and FIGS. 1B and 1C are schematic cross-sectional views illustrating the scanner 100.

The scanner 100 includes a sheet feed port 101 for feeding a document into the apparatus on the front side of the main body (upstream side in the Y direction), and a sheet feed plate 102 on which a document can be placed. The user places the leading edge of the document on the sheet feed plate 102 so that the center of sheet feed port 101 in the document width direction (X direction) faces the center of the document in the width direction. Then, the user inserts the document through the sheet feed port 101 by sliding it on the sheet feed plate 102.

In the conveyance path inside the scanner 100, the document inserted through the sheet feed port 101 is conveyed in the horizontal direction (Y direction) as a predetermined sheet conveyance direction perpendicular to the document width direction (X direction). The sheet feed port 101 is designed so that, when the user inserts a document, a positional deviation and inclination relative to the lateral length of the document readable by the scanner 100 are accepted to a certain degree. More specifically, the sheet feed port 101 is designed to be longer in the X direction than the maximum width (maximum length in the X direction) of the document readable by the scanner 100. The Z direction indicates the direction perpendicularly intersecting with the X and Y directions, i.e., the upward direction of the gravity direction.

The scanner 100 includes an operation panel 103 as a display unit on the top surface of the apparatus main body. The operation panel 103 is provided with physical keys and a Liquid Crystal Display (LCD) panel. The user operates the operation panel 103 to set reading conditions and input the document size.

The top surface of the scanner 100 is provided with a cover 104. The user can access the inside of the scanner 100 by upwardly rotating the cover 104 to open it. Thus, the user can perform the maintenance of the inside of the scanner 100.

The front (anterior) surface side of the apparatus main body of the scanner 100 refers to the side on which the user faces the scanner 100 when operating the scanner 100 in a normal use form. To make it easier for the user facing the front (anterior) surface of the apparatus main body of the scanner 100 to perform various operations, the sheet feed port 101 is open on the front surface side of the apparatus main body, and the operation panel 103 is disposed on the front surface side of the apparatus main body.

FIG. 1B is a cross-sectional view when viewed from the downstream side in the X direction. Referring to FIG. 1B, the sheet feed port (insertion port or carry-in port) 101 is disposed on the left-hand side, and the sheet discharge port (paper ejecting port or carry-out port) 111 is disposed on the right-hand side.

Referring to the schematic cross-sectional view in FIG. 1B, the left-hand side corresponds to the front (anterior) surface side of the apparatus main body, and the right-hand side corresponds to the depth side or back surface side of the apparatus main body.

FIG. 1C is a cross-sectional view when viewed from the upstream side in the X direction. More specifically, FIG. 1C is a drawing when viewed from the opposite side of FIG. 1B in the X direction. The left-hand side corresponds to the back surface side, and the right-hand side corresponds to the front surface side of the apparatus main body. The scanner 100 is often disposed above an image recording apparatus (printer) having a recording unit such as a recording head, and the installation method is not limited to a particular method.

A document detection sensor 105 for detecting that a document is inserted through the sheet feed port 101 is disposed in the vicinity and downstream of the sheet feed port 101 in the sheet conveyance direction. The document detection sensor 105 is a reflection-type optical sensor for detecting the presence of a document by emitting light onto the reading surface of the document inserted through the sheet feed port 101 and receiving the reflected light.

A conveyance roller 107 and an upstream pinch roller 108 are disposed downstream of the document detection sensor 105 in the sheet conveyance direction so that the two rollers can pinch a document. The conveyance roller 107 is connected with a conveyance motor 113 via a gear. When the conveyance roller 107 and the upstream pinch roller 108 are rotated by the rotation of the conveyance motor 113, the document can be conveyed in the Y direction.

Line image sensors 106 as reading units are disposed downstream of the conveyance roller 107 in the sheet conveyance direction. A pressing plate (not illustrated) is disposed to face the reading surfaces of the line image sensors 106. The pressing plate presses the document onto the reading surfaces of the line image sensors 106 via a biasing means such as a spring. The scanner 100 according to the present exemplary embodiment includes multiple (for example, five) small line image sensors 106 arranged in the X direction to read a document of a large size such as A1, B2, and A2.

A discharge roller 109 and a downstream pinch roller 110 are disposed downstream of the line image sensors 106 in the sheet conveyance direction so that the rollers can pinch a document. The discharge roller 109 and the downstream pinch roller 110 are also collectively referred to as a downstream roller pair. The discharge roller 109 is connected with the conveyance roller 107 via a belt 114. When the discharge roller 109 and the downstream pinch roller 110 are rotated by the rotation of the conveyance motor 113, the document is discharged to the sheet discharge port 111. The discharge roller 109 and the downstream pinch roller 110 according to the present exemplary embodiment can pinch and hold the document before it is discharged to the sheet discharge port 111. At this timing, if the conveyance roller 107 and the upstream pinch roller 108 are pinching a document, these rollers pinch and hold the document.

More specifically, the conveyance roller 107 and the discharge roller 109 are configured to receive a driving force transmitted from the conveyance motor 113 and rotate in association via the belt 114. On the other hand, the upstream pinch roller 108 receives a biasing force of a biasing means (e.g., a spring not illustrated) to be pressed onto the conveyance roller 107. Thus, the conveyance roller 107 and the upstream pinch roller 108 form a nip portion for pinching and conveying a document. The conveyance roller 107 and the upstream pinch roller 108 are also collectively referred to as an upstream roller pair.

Likewise, the downstream pinch roller 110 receives a biasing force of a biasing means (e.g., a spring not illustrated) to be pressed onto the discharge roller 109. Thus, the discharge roller 109 and the downstream pinch roller 110 form a nip portion for pinching and conveying a document.

The upstream pinch roller 108 and the downstream pinch roller 110 are driven to rotate by the rotations of the conveyance roller 107 and the discharge roller 109, respectively. While the conveyance roller 107 and the discharge roller 109 are stopped, the upstream pinch roller 108 and the downstream pinch roller 110 keep being stopped, respectively.

The conveyance detection sensor 112 is an encoder that detects the rotation of the conveyance motor 113 and outputs a signal. As described above, the conveyance motor 113 is mechanically connected with the conveyance roller 107 and the discharge roller 109. Accordingly, if the document is moved from the outside while being nipped (pinched) via different roller pairs, the conveyance roller 107 and the discharge roller 109 are slightly rotated by the movement of the document. The conveyance detection sensor 112 can detect the movement of the conveyance motor 113 associated with the rotations of the conveyance roller 107 and the discharge roller 109.

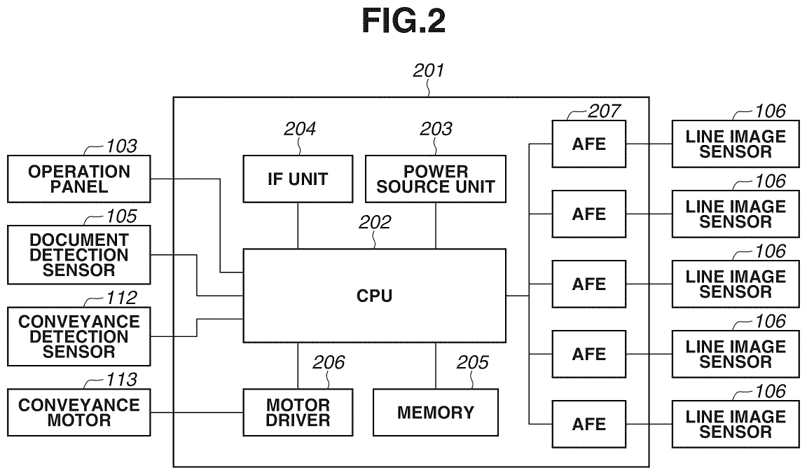

FIG. 2 is a block diagram illustrating an electrical configuration of the scanner 100. The scanner 100 includes a controller board 201 as a control unit to control different sensors and actuators. A central processing unit (CPU) 202 is mounted on the controller board 201. The CPU 202 is connected with a power source unit 203, an IF (interface) unit 204, a memory 205, a motor driver 206, an analog front end (AFE) 207, an operation panel 103, and sensors.

The power source unit 203 includes a circuit for converting power supplied from the outside into voltages to be used to drive the controller board 201, sensors, and actuators. The IF unit 204 includes control circuits such as a Local Area Network (LAN) and a Universal Serial Bus (USB), and connects the CPU 202 with a personal computer (PC) and a network to enable data communication.

The memory 205 stores a program for driving the CPU 202 and is used as a buffer for processing read image data acquired from the line image sensors 106. The memory 205 is also used to store a threshold value for determination in discharge control performed based on the output of the conveyance detection sensor 112.

The motor driver 206 is used to drive the conveyance motor 113 as a direct-current (DC) motor. The motor driver 206 receives a control signal input from the CPU 202 and outputs a motor drive signal. The AFE 207 converts analog read signals output from the line image sensors 106 into digital data, and includes circuits of which the number corresponds to the number of line image sensors 106.

The operation panel 103 is operated by the user to operate the scanner 100, and includes an LCD, a touch panel, and physical keys. The LCD displays menus and notifications, and the user starts the scan operation and changes settings through touch panel operations. Examples of the physical keys include a start key, a stop key, and a discharge key.

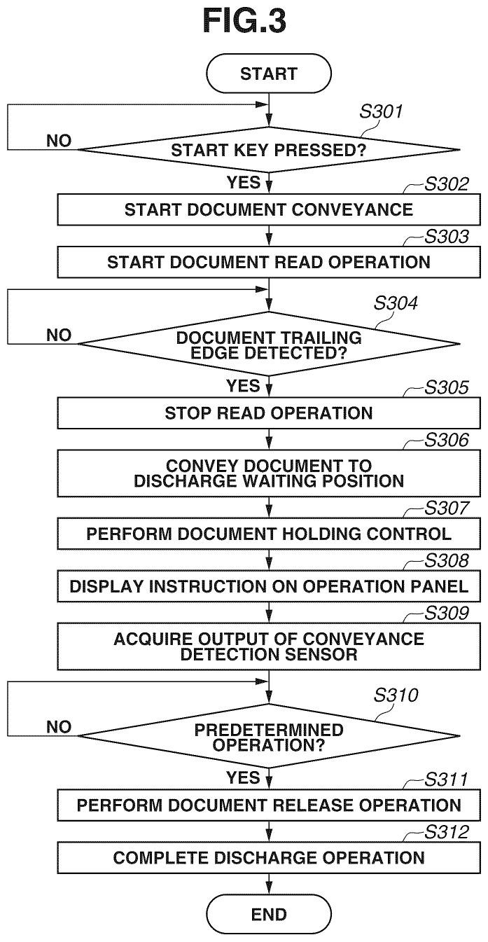

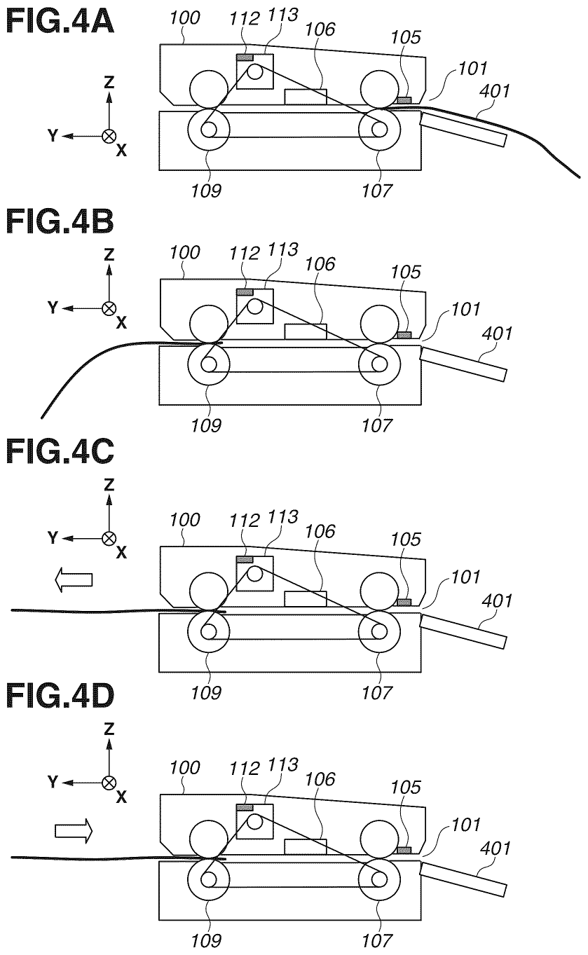

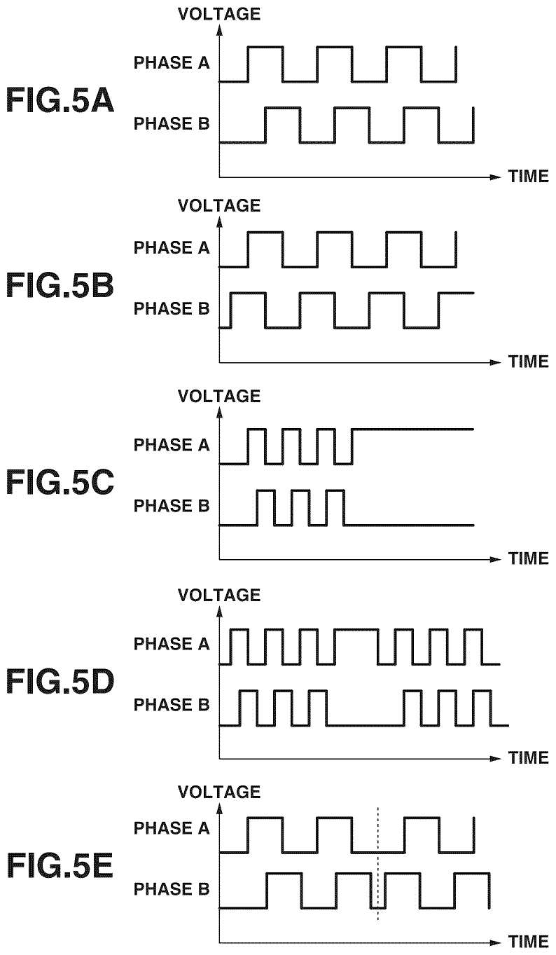

Document discharge processing according to the present exemplary embodiment will be described below with reference to FIGS. 3 to 5E. FIG. 3 is a flowchart illustrating a series of processing ranging from reading a document set (supplied) to the scanner 100 to discharging the document. FIGS. 4A to 4D are cross-sectional views illustrating the states of a document 401 on the scanner 100 and the detection states of the conveyance detection sensor 112. FIGS. 5A to 5E illustrate relations between the outputs of the conveyance detection sensor 112 and a user action to pull the document (predetermined action).

FIGS. 4A to 4D are schematic cross-sectional views illustrating the scanner 100 when viewed from the upstream in the X direction.

When reading the document 401 by using the scanner 100, the user needs to set (supply) the document 401 to the scanner 100 in advance as illustrated in FIG. 4A. When the user inserts the document 401 through the sheet feed port 101, the document detection sensor 105 detects the document 401 and transmits a signal to the CPU 202.

The CPU 202 transmits a control signal to the motor driver 206 to rotate the conveyance roller 107 to rotate the conveyance motor 113 to convey the document 401 downstream in the sheet conveyance direction (Y direction). When the document 401 reaches the reading start position facing the line image sensors 106, the CPU 202 stops the rotation of the conveyance motor 113 to stop the sheet conveyance. The state of the document 401 illustrated in FIG. 4A is also referred to as a standby state. In this state, the CPU 202 receives an operation on the operation panel 103, and the user operates the operation panel 103 to change read settings. The method for receiving an operation is not limited to the method of using the operation panel 103. The CPU 202 may receive an operation via a host computer, a portable terminal, or a smart phone.

In step S301, while the document 401 is in the standby state, the CPU 202 waits until the user presses the start key (a key for issuing a read instruction) on the operation panel 103. When the user presses the start key (YES in step S301), the CPU 202 starts a read operation.

In step S302, the CPU 202 transmits a control signal to the motor driver 206 to rotate the conveyance motor 113 to start the conveyance of the document 401. The CPU 202 accelerates the conveyance of the document 401 until the leading edge of the document 401 reaches the line image sensors 106. After the leading edge reaches the line image sensors 106 (during read operation), the CPU 202 controls the conveyance of the document 401 at a constant speed.

The CPU 202 calculates the position of the document 401 in the sheet conveyance direction based on the control signal to the motor driver 206. When the CPU 202 determines that the leading edge of the document 401 reaches the line image sensors 106, then in step S303, the CPU 202 transmits drive signals to the line image sensors 106 and the AFE 207 to start the read operation for the document 401. The data output from the line image sensors 106 is converted into a digital value by the AFE 207 and then input to the CPU 202. The CPU 202 converts the data input from the line image sensors 106 into one piece of image data and then stores the image data in the memory 205. The stored image data is sequentially read from the outside via the IF unit 204.

In step S304, while the CPU 202 is performing the read operation during conveyance of the document 401, the CPU 202 detects the trailing edge of the document 401 via the document detection sensor 105. When the conveyance of the document 401 is continued, and the trailing edge of the document 401 passes through the detection area detectable by the document detection sensor 105, the output signal of the document detection sensor 105 changes, and the CPU 202 detects the trailing edge of the document 401.

When the CPU 202 determines the position for completing the read operation of the document 401 based on the detected trailing edge position, and the document 401 reaches that position (YES in step S304), the processing proceeds to step S305. In step S305, the CPU 202 stops the control signals of the line image sensors 106 and the AFE 207 and completes the read operation.

Upon completion of the read operation as illustrated in FIG. 4B, then in step S306, the CPU 202 controls the drive of the conveyance motor 113 so that the trailing edge of the document 401 stops at a predetermined position (discharge waiting position).

In a state where the rotation of the conveyance motor 113 is stopped, the trailing edge of the document 401 is pinched by the discharge roller 109 and the downstream pinch roller 110, as illustrated in FIG. 4B. Meanwhile, the leading edge of the document 401 is discharged from the sheet discharge port 111 to the outside. In step S307, to lock the rotation of the discharge roller 109 to prevent the document 401 from dropping out of the apparatus by its own weight, the CPU 202 controls the motor driver 206 to activate the conveyance motor 113.

In step S308, while maintaining a state where the conveyance of the document 401 is stopped and the rotation of the discharge roller 109 is locked, the CPU 202 displays on the operation panel 103 an instruction for prompting the user to move the document 401 with a predetermined action. The instruction in step S308 may be displayed not only on the operation panel 103 but also on the screen of the computer, portable terminal, or smart phone connected via the driver.

In step S309, the CPU 202 acquires the output of the conveyance detection sensor 112. Because the conveyance detection sensor 112 has a high detection resolution, the sensor 112 may detect a slight rotation of the conveyance motor 113 if the user touches the document 401 without intending to discharge it or if the scanner 100 shakes. In such a case, the CPU 202 may possibly erroneously detect the predetermined action of the user. A method for avoiding such false detection by the conveyance detection sensor 112 will be described below with reference to FIGS. 5A to 5E.

FIGS. 5A to 5E are schematic views illustrating output waveforms of the encoder used as the conveyance detection sensor 112. The vertical axis indicates the voltage, and the horizontal axis indicates time. The CPU 202 can detect the rotational direction of the conveyance motor 113 depending on which one of the waveforms of phases A and B (two-phase output) of the conveyance detection sensor 112 lags behind the other.

Assume a case where the user performs an action to pull the document 401 in the discharge direction (downstream in the Y direction), as illustrated in FIG. 4C. Since the document 401 is nipped by the discharge roller 109 and the downstream pinch roller 110 (downstream roller pair) with the rotation locked, the document 401 is not pulled out. However, since the conveyance roller 107, the discharge roller 109, and the conveyance motor 113 are mechanically connected with the belt 114, there is a play (gap) by a spring for applying a tension to the belt 114.

For this reason, the conveyance roller 107 and the discharge roller 109 slightly rotate in the discharge direction of the document 401 by the user's pulling action. At this timing, since the conveyance motor 113 mechanically connected also slightly rotates, the CPU 202 acquires an output illustrated in FIG. 5A from the conveyance detection sensor 112. More specifically, if the conveyance roller 107 and the discharge roller 109 rotate in the discharge direction of the document 401 (counterclockwise direction in FIG. 4C), the conveyance detection sensor 112 outputs waveforms in which phase B lags behind phase A.

For example, if the CPU 202 acquires continuous pulses of the number equal to or larger than a predetermined number, as illustrated in FIG. 5C, the CPU 202 determines that the user is pulling the document 401 (performing the predetermined action). The CPU 202 can also determine that the user is pulling the document 401 (performing the predetermined action) if the CPU 202 acquires continuous pulses a predetermined number of times during a predetermined period, as illustrated in FIG. 5D.

If the user pulls the document 401 in the discharge direction (downstream in the Y direction) and then moves the document 401 in the opposite direction (upstream in Y direction), the conveyance detection sensor 112 outputs waveforms in which phases A and B are reversed in the middle of waveforms, as illustrated in FIG. 5E. More specifically, the conveyance detection sensor 112 outputs waveforms in which phase B lags behind phase A and then, at the timing of the dotted line in FIG. 5E, outputs waveforms in which phase A lags behind phase B.

This is because the conveyance roller 107 and the discharge roller 109 rotate in the direction opposite to the discharge direction of the document 401.

According to the present exemplary embodiment, if the conveyance detection sensor 112 outputs the waveforms illustrated in FIGS. 5C to 5E, the CPU 202 determines that the user has performed the predetermined action (the action specified on the operation panel 103). In step S310, the CPU 202 determines whether the output waveforms of the encoder are caused by the predetermined action.

If the CPU 202 determines that the user performs the predetermined action (YES in step S310), the processing proceeds to step S311. In step S311, the CPU 202 cancels holding control for the document 401 and then discharges the document 401 (by restarting the rotation of the discharge roller 109 and the downstream pinch roller 110).

To discharge the document 401, the CPU 202 transmits a control signal to the motor driver 206 to rotate the conveyance motor 113. When the conveyance motor 113 rotates, the discharge roller 109 and the downstream pinch roller 110 rotate, and the trailing edge of the document 401 having been held is discharged through the sheet discharge port 111. In step S312, when the document 401 is discharged, the user holds both ends of the document 401 with both hands and hence can collect the document 401 without dropping, folding, or curving.

According to the present exemplary embodiment, the holding by the downstream roller pair is automatically released when the state of the document 401 changes. This allows the user to collect the document 401 simply by pulling it without performing any operation on the operation panel 103. More specifically, the user can release the state where the document 401 is held not to drop from the sheet discharge port 111 by its own weight, without performing any operation from the operation panel 103. This enables preventing the document 401 even with a large size from being damaged by dropping, folding, or curving.

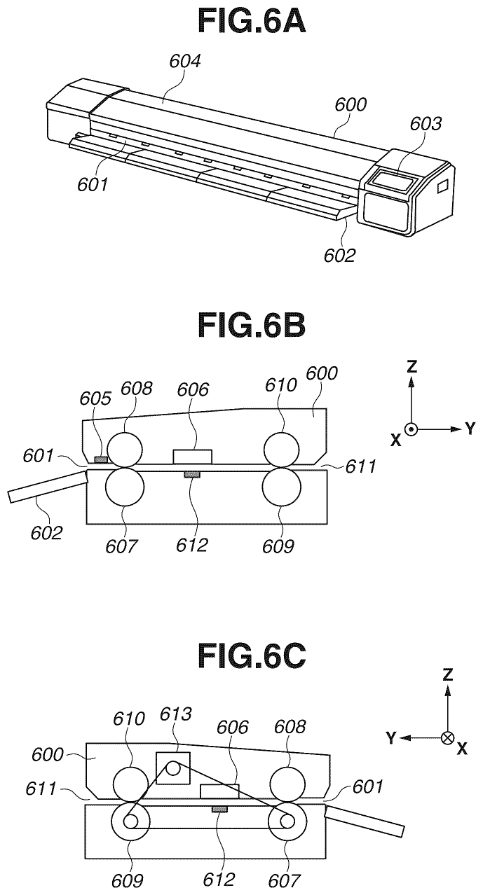

Although the present exemplary embodiment has been described above centering on a configuration where the conveyance detection sensor 112 detects the sheet conveyance based on the movement of the conveyance motor 113, the sheet conveyance may be detected with other configurations. FIGS. 6A to 6C illustrate another exemplary embodiment. FIG. 6A is a perspective view illustrating the outer appearance of a scanner 600. FIG. 6B is a cross-sectional view illustrating the scanner 600 when viewed from the downstream side in the X direction. FIG. 6C is a cross-sectional view illustrating the scanner 600 when viewed from the upstream side in the X direction.

According to other exemplary embodiments, a conveyance detection sensor 612 is disposed to face line image sensors 606, as illustrated in FIGS. 6B and 6C. In this configuration, the conveyance detection sensor 612 detects the sheet conveyance independently of the movement of a conveyance motor 613. Accordingly, by conveying the document 401 in the direction opposite to the discharge direction up to the position where the document 401 can be read by the conveyance detection sensor 612 in the processing in step S306 in FIG. 3 after completion of the read operation for the document 401, the CPU 202 can execute the processing in step S307 and subsequent steps in a similar way to the first exemplary embodiment.

The above-described exemplary embodiment is based on the configuration and control of the scanner 600. In the case of a multifunction printer (MFP) integrated with a printer, a printer unit performs a printing operation in parallel with a document read operation. In this case, a vibration caused by the drive of a carriage unit for moving the printer unit or a vibration caused by the document conveyance may possibly affect the signal level to be detected by the conveyance detection sensor 112.

In this case, for example, an output acquisition period of the conveyance detection sensor 112 may be set in consideration of the range of output variations due to vibrations associated with the carriage unit and sheet conveyance in the printer unit. Thus, when the CPU 202 performs the determination in step S310 in FIG. 3, the CPU 202 acquires the output of the conveyance detection sensor 112 based on the vibration of the apparatus to prevent erroneous determination that the user performs the predetermined action.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-185102, filed Oct. 27, 2023, which is hereby incorporated by reference herein in its entirety.

What is claimed is:

1. A reading apparatus comprising:
a first roller pair configured to convey a document in a first direction;
a reading unit provided downstream of the first roller pair in the first direction and configured to read the document;
a second roller pair provided downstream of the reading unit in the first direction and configured to convey the document;
a discharge port provided downstream of the second roller pair in the first direction and configured to discharge the document out of the apparatus;
a motor configured to drive the second roller pair;
a sensor configured to detect a rotation of the motor; and
a control unit configured to, in a case where the sensor detects a predetermined rotation of the motor in a state where the document having been read by the reading unit is held and stopped via the second roller pair, drive the second roller pair to discharge the document from the discharge port.

2. The reading apparatus according to claim 1,
wherein the sensor includes an encoder, and
wherein, upon acquisition of a predetermined output of the encoder, the control unit drives the second roller pair to discharge the document from the discharge port.

3. The reading apparatus according to claim 2,
wherein, upon acquisition of continuous pulses from the encoder a first number of times, the control unit drives the second roller pair to discharge the document from the discharge port, and
wherein, upon acquisition of continuous pulses a second number of times fewer than the first number of times, the control unit maintains the state where the document is held by the second roller pair.

4. The reading apparatus according to claim 1, wherein, in a case where the sensor detects that the motor rotates in the first direction and then rotates in a second direction opposite to the first direction, the control unit drives the second roller pair to discharge the document from the discharge port.

5. The reading apparatus according to claim 1, wherein, in a state where the document having been read by the reading unit is held via the second roller pair, the control unit prompts a user to perform a predetermined action.

6. The reading apparatus according to claim 1, further comprising a display unit configured to display a message to the user.

7. A recording apparatus comprising:
a first roller pair configured to convey a document in a first direction;
a reading unit provided downstream of the first roller pair in the first direction and configured to read the document;
a second roller pair provided downstream of the reading unit in the first direction and configured to convey the document;
a discharge port provided downstream of the second roller pair in the first direction and configured to discharge the document out of the apparatus;
a motor configured to drive the second roller pair;
a sensor configured to detect a rotation of the motor;
a recording unit configured to record an image read by the reading unit; and
a control unit configured to, in a case where the sensor detects a predetermined rotation of the motor in a state where the document having been read by the reading unit is held and stopped via the second roller pair, drive the second roller pair to discharge the document from the discharge port.

8. A method for controlling a reading apparatus that includes a first roller pair configured to convey a document in a first direction, a reading unit provided downstream of the first roller pair in the first direction and configured to read the document, a second roller pair provided downstream of the reading unit in the first direction and configured to convey the document, a discharge port provided downstream of the second roller pair in the first direction and configured to discharge the document out of the apparatus, and a motor configured to drive the second roller pair, the method comprising:
holding and stopping the document having been read by the reading unit, via the second roller pair;
detecting a rotation of the motor after the stopping; and
driving, in a case where a predetermined rotation is detected in the detecting, the second roller pair to discharge the document from the discharge port.
